(19) United States
(12) Patent Application Publication
(10) Pub. No.: US 2023/0051772 A1
(43) Pub. Date: Feb. 16, 2023

(54) METHOD AND APPARATUS FOR MONITORING THE MANUFACTURING PROCESS OF PLASTIC CONTAINERS

(71) Applicant: KRONES AG, Neutraubling (DE)

(72) Inventor: Patrick ENGELHARD, Elsendorf (DE)

(21) Appl. No.: 17/884,172

(22) Filed: Aug. 9, 2022

(30) Foreign Application Priority Data
Aug. 16, 2021 (DE) 10 2021 121 175.1

(51) Int. Cl. B29C 49/42; B29C 49/12; B29C 49/48

(52) U.S. Cl. CPC B29C 49/42412; B29C 49/12; B29C 49/48; B29L 2031/7158

(57) ABSTRACT

Disclosed is a method for monitoring a product cycle in the production of plastic containers, wherein a plastic preform is provided and a plastic container with a marking is produced by a blow moulding process, which marking is configured to uniquely identify the plastic container, to wherein the production of the marking takes place during a manufacturing process of a plastic preform or the plastic container.

### BACKGROUND OF THE INVENTION

The present invention relates to a method and an apparatus for monitoring the manufacturing and further processing processes of plastic containers and, in particular, plastic bottles. Numerous manufacturing cycles are known from the prior art, which include, for example, the manufacturing of plastic bottles, the filling thereof, the labelling and also the further processing. With such apparatus and methods, there is a need to monitor or customise the corresponding container over its lifetime.

For example, it is known from the state of the art to generate imprints on the containers with to the help of which these containers can be individualised or identified. Recyclable plastic containers such as PET bottles (ref-PET) are currently produced as unmarked mass-produced articles. They then go through several cycles (cleaning, filling, consumption), wherein the history of these cycles is not known. So far, the only method in the state of the art for serialisation or identification is the surface printing of the containers, for example by means of digital direct printing.

Since the history of ref-PET bottles is not known, a very intensive cleaning process must be used for all bottles. Nevertheless, not all flavouring substances can be removed, which can lead to off-flavours with changing and sensitive products (e.g. water). Printing on the containers is critical because the print is usually not durable over several cleaning cycles of the bottles.

### SUMMARY OF THE INVENTION

The present invention is therefore based on the object of improving the marking and/or identification of plastic bottles. According to the invention, these objects are achieved by the subject matters of the independent patent claims. Advantageous embodiments and further developments are the subject of the subclaims.

In a method according to the invention for monitoring a product cycle comprising the production of plastic containers and/or for monitoring a manufacturing process for producing plastic containers, a plastic container with a marking is produced by a blow moulding to operation, wherein said marking being suitable and intended for uniquely identifying the plastic container.

According to the invention, the marking is produced during a manufacturing process of a plastic preform or the plastic container. Preferably, the manufacturing process of the container is a blow moulding process and in particular a stretch blow moulding process.

Preferably, the product cycle has further method steps, such as filling the containers, labelling, grouping into container groups, sale and recycling activities. Preferably, the plastic container is a recyclable plastic container and in particular a recyclable plastic bottle.

In a further preferred method, the product circuit is a product circuit for recyclable plastic containers. In particular, these are recyclable beverage containers or beverage bottles. Preferably, the containers are recyclable PET containers (ref-PET).

In a preferred method, the marking is applied and/or created on an outer surface of the container. In the following, different manufacturing processes are described that enable such a marking to be applied to the container. Preferably, the plastic material of the container is acted upon to apply and/or create the marking.

Particularly preferably, the marking is selected from a group of markings comprising barcodes, QR codes, RFID codes, matrix codes and the like. Preferably, the marking is optically readable.

Preferably, the marking is characteristic of at least one feature of the plastic bottle and/or of the liquid contained in the bottle (which is in particular a beverage). This can be, for example, a date of manufacture of the bottle, a material of the bottle, a volume of the bottle, a filling time of the content of the container, a brand of the product to be filled, an expiry date of the product and the like.

Particularly preferably, the container is transported from a manufacturing station where it is produced to a further processing station. This can be, for example, a sterilising device which sterilises the container, a filling device which fills the container, a labelling device which to labels the container and the like.

However, it is particularly suggested that the marking is applied during the manufacturing process. Preferably, the mark is a permanent mark that is permanently attached to the container. Preferably, the “lifetime” of the mark corresponds to the “lifetime” of the container.

It is thus proposed that individualisation of the bottle takes place during the production of the bottle. Preferably, as mentioned above, this should be done at or during the stretch blow moulding process. However, it would also be possible to create the marking during the production of the plastic preform.

Particularly preferably, the plastic material, for example PET material of the container, is (locally) changed and/or a topological code is applied to the container by the method described in more detail below. In a further preferred method, the marking is applied by a mechanical action on the plastic material. In particular, on the material of a preform or a container (being formed).

Preferably, the marking is a topological marking. This means that this marking preferably has height differences on the surface (in particular in relation to the surrounding areas of the plastic container). Particularly preferably, these differences are less than 1 mm, preferably less than 0.8 mm, preferably less than 0.6 mm, preferably less than 0.4 mm. In a further preferred method, these height differences are greater than 0.05 mm, preferably greater than 0.06 mm, preferably greater than 0.08 mm, preferably greater than 0.1 mm and particularly preferably greater than 0.2 mm.

In a preferred embodiment, the marking is raised relative to the marking in adjacent areas of the plastic container. In a further preferred embodiment, the marking is recessed relative to the marking in adjacent areas of the plastic container or directed towards the interior of the container. This can be achieved in each case by a suitable choice of a stamp element which produces the marking.

Preferably, the marking applied to the containers is haptically and/or visually perceptible.

Preferably, the marking is placed in an area of the container that is not or will not be covered to by a label.

In a further preferred method, the marking is applied in a heated state of the plastic material. This means that at the time the mark is applied the plastic material is at a temperature greater than room temperature, preferably greater than 20° C., preferably greater than 30° C., preferably greater than 40° C. Particularly preferably, the marking is applied to the container at a temperature lower than 200° C., preferably lower than 150° C., preferably lower than 100° C.

In a further preferred method, the mark is applied to the container during a stretch blow moulding operation.

Thereby, particularly preferably during the stretch blow moulding process, a first area of the plastic preform is deformed and a second area of the plastic preform is not deformed and the marking is applied in the first area which is deformed.

Usually, in the production of plastic bottles from plastic preforms, the mouth and/or threaded areas are not stretched, but only the base bodies of the plastic preform adjoining these threaded areas. The marking is preferably applied in the said area of the plastic preform or plastic container to be stretched or stretched.

In a further preferred method, during the stretch blow moulding process, the plastic preform is expanded inside a blow mould against an inner wall of this blow mould, and the said marking is produced by the plastic material contacting the inner wall.

Particularly preferably, at least one area of the inner wall forms a negative of the marking to be produced. Particularly preferably, this negative is adjustable. Preferably, the blow mould has at least two side parts and also a bottom part, which together form the cavity for expanding the plastic preform.

In a further preferred method, the marking is made by a stamp element arranged or formed on or in the inner wall of the blow mould. This can be adjustable pins, as explained in more detail below, but it would also be conceivable for an additional stamp element to be inserted into the blow mould.

If the marking is applied topologically, it is preferably possible to provide a blow mould with an adjustable surface and in particular an inner surface. For this purpose, an automatic stamp and/or an automatically adjustable area can be installed in a (particularly small) area of the blow mould, so that an individual code or individual marking can be generated. For example, small pins that can be retracted or extended by drive elements such as piezo actuators can serve as the mechanism. In addition, a mechanism such as that used in automatically adjustable date stamps would also be conceivable.

In addition, it would also be possible for an embossing element such as a metal strip to be pre-embossed, then inserted into the blow mould together with the plastic preform and, particularly preferably, ejected together with the moulded bottle.

In addition, it would also be possible for a change in the PET material to be locally defined by a laser, for example. In this way, it is possible that a numerical code or 3D code results. This can, for example, be read out again using suitable methods such as optical methods for detecting light refraction.

The invention makes it possible to uniquely identify and/or serialise ref-PET containers. The marking or code is forgery-proof and permanently attached to the container. In addition, no foreign material such as printing ink is required on the container. Preferably, the marking is created in a side wall of the plastic container.

In a particularly preferred method, the marking is produced by a stamp element arranged or inserted on or in the inner wall of the blow mould.

In a further preferred method, a first information which is characteristic of the container and/or the marking is stored in a memory device in a further method step. In this way, further tracking of the container can be made possible. Particularly preferably, further processing of the container takes place in a first further processing step. This may, for example be labelling the container or filling the container.

In a further preferred method, a second information is stored that is characteristic of this further processing operation and/or the further processed container that is created in this to way. In addition, it is also possible that an information is changed or a stored information that can be assigned to the marking is changed.

This information preferably relates to the plastic container and/or the liquid filled into it. At each further processing step of this plastic container, the information about this product can be supplemented or changed. For example, during the production of the marking, and thus of the plastic container, information about the material used for the production, about the machine that produced the plastic container, about a supplier of the material and the like can be assigned.

Preferably, a kind of logbook is produced or created which is assigned to this plastic container, wherein this logbook can be supplemented, for example, during further processing steps.

In the case of further processing of the plastic container, information can be stored that relates to this further processing operation, for example, on which machine the further processing took place or which other materials (such as labels or a sterilisation medium) were used.

This respective information can be tracked throughout the whole life cycle of the plastic container and ultimately even during recycling steps of the respective product. In this way, the product can be tracked through the product cycle and information about each individual product can be retrieved and/or changed.

In a further preferred method, the marking is applied to the container without the use of additional consumables. As mentioned above, the marking is preferably applied without the use of additional materials such as ink and the like.

The present invention is further directed to a mould and in particular a blow mould for producing a plastic container, wherein said blow mould comprising several blow mould parts which can be assembled to form a cavity within which the plastic containers can be moulded, wherein said blow mould parts comprise and/or form an inner wall, against which the plastic material of the plastic container can be pressed and wherein in at least one region of this inner wall a marking production device and in particular a stamping element is or can be arranged which is suitable and intended for applying a marking (and in particular a marking which can be read by machine and in particular optically) to a plastic container.

According to the invention, this stamp element can be changed so that different markings can be applied to different plastic containers with the same blow mould.

Preferably, the marking device is suitable and intended to apply a marking to the container which uniquely identifies this container.

Particularly preferably, the blow mould parts of the blow mould are at least two side parts and one bottom part.

Preferably, in an assembled state, the blow mould has an opening through which a mouth of the plastic container located in the blow mould is accessible so that it can be acted upon by blowing air, for example.

In a further preferred embodiment, the marking production device has at least one projection element which is arranged in a predetermined region of the inner wall and which is movable relative to the inner wall. Preferably, the mould or blow mould has several such projection elements. The projection elements can be pins. For example, they may be movable into the interior of the blow mould so that they can create a corresponding marking in the container. Preferably, the at least one projection element is linearly movable.

Particularly preferably, the mould has an actuator device for moving this projection element. For example, a plurality of projection elements in the form of pins or needles can be provided, which are preferably individually movable so that different markings can be produced.

The present invention is further directed to an apparatus for manufacturing plastic containers comprising at least one mould of the type described above and an actuator means for adjusting the making production device or stamping element. Particularly preferably, these above-mentioned projections are arranged in a side wall of the blow mould. Particularly to preferably, the apparatus is a blow moulding machine and in particular a stretch blow moulding machine or the apparatus comprises such a blow moulding machine. In this case, this blow mould can have a plurality of forming and/or blowing stations, each of which is suitable and intended for forming plastic preforms into plastic containers. Particularly preferably, each of these forming stations comprises a blow mould of the type described above with a corresponding stamping element.

In a further preferred embodiment, the apparatus has at least one transport device that transports the containers along a predetermined transport path. Preferably, the blow moulding machine has such a transport device, for example in the form of a blowing wheel. A further transport device can also be provided, which feeds plastic preforms to the blow moulding machine and/or which removes plastic containers produced by the blow moulding machine and, in particular, takes them away for further processing.

Particularly preferably, the apparatus is designed as a rotary device. In this case, a plurality of forming stations can be arranged on a rotatable carrier.

In a preferred embodiment, the apparatus comprises a stretching rod which is insertable into the plastic preforms or is insertable to stretch them. Preferably, each of the blow moulds has such a stretching rod. Particularly preferably, a heating device is arranged upstream of the apparatus, which serves to heat the plastic preforms.

In a further advantageous embodiment, the apparatus comprises a processor device which is suitable and intended to issue instructions to the stamping element for adjustment. In this way, a variety of different markings can be applied to containers using one blow mould.

Preferably, a memory device is provided which stores the instructions issued by the processor device.

Preferably, as mentioned, the apparatus has a plurality of such moulds. These preferably each have adjustable marking production devices or stamping devices. Each blow mould can also have a characteristic element which uniquely identifies this blow mould, such as a fixed marking production element (of the marking production device) or stamping element. In this way, it would be possible to trace which blow mould was used to produce a particular to container.

Particularly preferably, the apparatus has a control device that causes the generation of a corresponding marking. This marking can also be forwarded to further machines in the system for producing the plastic containers.

### BRIEF DESCRIPTION OF THE DRAWINGS

Further advantages and embodiments can be seen in the attached drawings:

In the drawings:

FIG. 1 shows a diagram illustrating the method according to the invention;

FIG. 2 shows a roughly schematic representation of a blow moulding machine;

FIG. 3 shows a roughly schematic representation of a blow mould;

FIG. 4 shows a representation of a side part of a blow mould; and

FIG. 5 shows a representation of a further embodiment of a method according to the invention

### DETAILED DESCRIPTION OF THE INVENTION

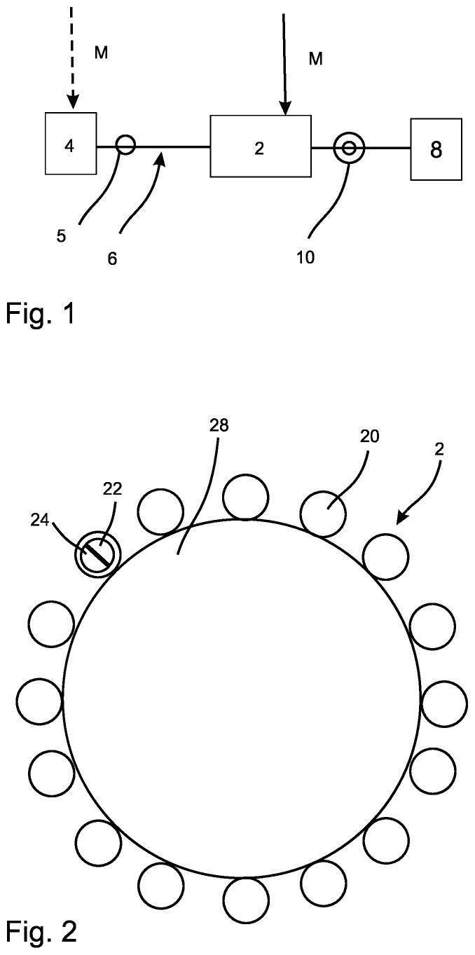

FIG. 1 shows a diagram illustrating a method according to the invention. In this method, plastic preforms 5 are produced by means of an optional production device 4 such as an injection moulding machine. A marking M can already be incorporated into these plastic preforms in this method step.

However, it would also be possible for (not yet marked) plastic preforms to be made available by means of a (not shown) reservoir. The reference sign 6 indicates a transport device which transports the (marked or unmarked) plastic preforms to a blow moulding machine 2.

This blow moulding machine 2 preferably has an upstream oven (not shown) which heats the plastic preforms. The plastic preforms are then expanded in the stretch blow-moulding machine 2 to form plastic containers and in particular plastic bottles. If the marking M was not already applied during the production of the plastic preforms, it is now applied during the blow moulding process.

The plastic containers marked M are then transported to a further processing device 8 and processed further there. This further processing device can be, for example, a filling device which fills the containers with a liquid and in particular with a beverage.

FIG. 2 shows a schematic representation of a blow moulding machine 2, which has a rotatable carrier 28 on which a plurality of blow moulds 20 are arranged. These blow moulds are each part of (not shown in more detail) forming stations, which are each used to form the plastic preforms into plastic containers.

The individual blow moulds 20 each have side parts 22, 24, and a bottom part (not shown).

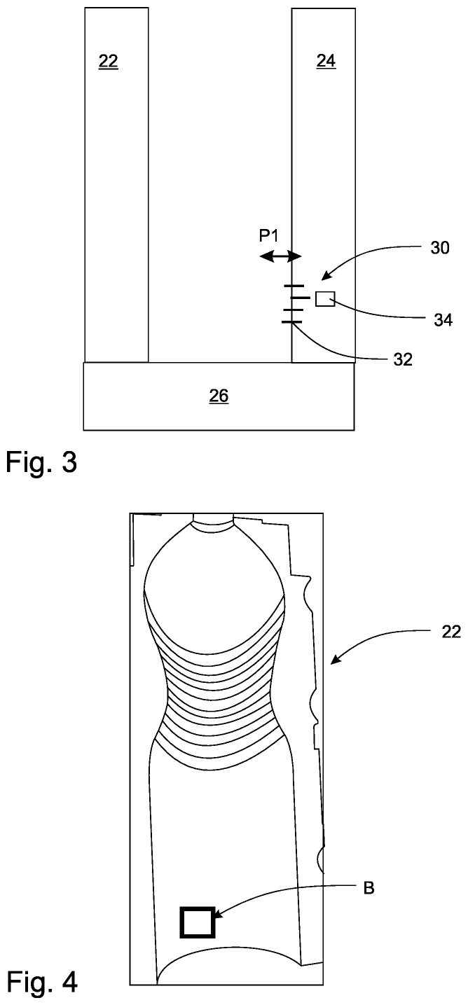

FIG. 3 shows a schematic representation of a blow mould 20, which has two side parts 22 and 24 and a base part 26. A marking production device 30 is integrated into the side part 24. This marking production device has a number of pins 32, each of which can be moved in the direction P1. It can be seen that in FIG. 3 three such pins protrude into the interior of the blow mould and one pin is retracted. Thus, in this example, the marking would be produced by the three pins. Preferably, the marking device has at least 5, preferably at least 10 and more preferably at least 20 such pins.

With a suitable number of pins, numerous different markings can also be created in this way.

The reference sign 34 roughly schematically indicates an actuator for moving the pins. It is possible that such an actuator 34 is assigned to each of the pins 32. Preferably, the actuator is a piezo actuator. This actuator or these actuators can be integrated in the side part 24 but also in a (not shown) carrier of the blow mould.

FIG. 4 shows an illustration of a side part 24. Here, one can see an area B in which the above-mentioned marking production device is arranged.

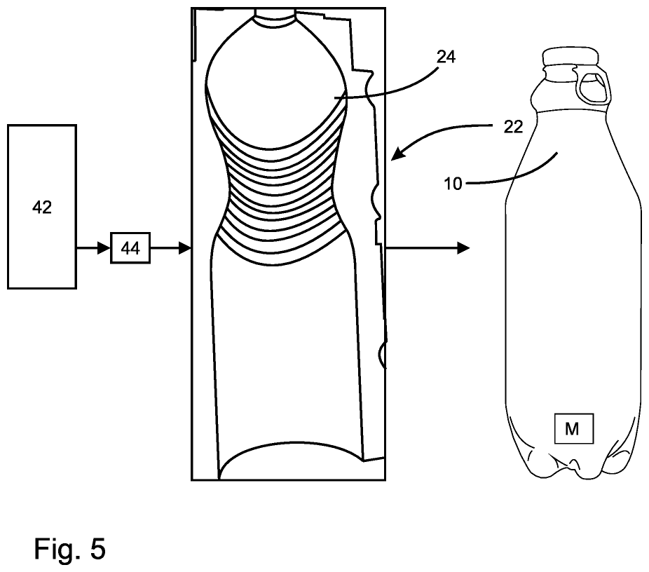

FIG. 5 shows an illustration of a further method according to the invention. Here is a stamp to generating device 42 which generates a stamp 44 having a specific marking and/or a negative of this marking. This stamp is preferably inserted into the mould 24 during the blow moulding process, thus producing the marking M on the container 10.

The applicant reserves the right to claim all features disclosed in the application documents as essential to the invention, provided that they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

1. A method for monitoring a product cycle comprising the production of plastic containers, wherein a plastic preform is provided and a plastic container with a marking is produced by a blow moulding process, which marking is configured for uniquely identifying the plastic container,
wherein
the marking is produced during a production process of a plastic preform or of the plastic container.

2. The method according to claim 1,
wherein
the marking is applied by a mechanical action on the plastic material of the plastic preform or the plastic container.

3. The method according to claim 1,
wherein
the product circuit is a product circuit for recyclable plastic containers.

4. The method according to claim 1,
wherein
the marking is a topological marking.

5. The method according to claim 1,
wherein
the marking is applied in a heated state of the plastic material.

6. The method according to claim 1,
wherein
the marking is applied to the container during the blowing process.

7. The method according to claim 6,
wherein
during the stretch blow moulding process a first area of the plastic preform is deformed and a second area of the plastic preform is not deformed and the marking is applied in the first area.

8. The method according to claim 1,
wherein
during the blowing process the plastic preform is expanded inside a blow mould against an inner wall of this blow mould and the marking is produced by the plastic material being applied to the inner wall.

9. The method according to claim 8,
wherein
the marking is carried out by a marking production device arranged or formed on or in the inner wall of the blow mould.

10. The method according to claim 1,
wherein
a stamping element is introduced into the blow mould in addition to the plastic preform.

11. The method according to claim 1,
further comprising
a further step in which, a first information which is characteristic for the plastic container, a filling material of the plastic container and/or the marking is stored in a memory device.

12. The method according to claim 1,
wherein
the marking is applied to the container without the use of additional consumables.

13. A mould, in particular a blow mould, for producing a plastic container, wherein this mould has a plurality of blow mould parts which are configured to be assembled to form a cavity within which the plastic containers can be moulded, wherein these blow mould parts have an inner wall against which the plastic material of the plastic container can be pressed, wherein in at least one region of this inner wall a marking production device is arranged which is configured for applying a marking to the plastic container,
wherein
this marking production device can be changed so that different markings can be arranged on different plastic containers.

14. The mould according to claim 13,
wherein
the marking production device has at least one projection element which is arranged in a predetermined region of the inner wall and which is movable relative to the inner wall.

15. An apparatus for producing plastic containers comprising a mould according to claim 13 and an actuator for adjusting the marking production device.
